(19) United States
(12) Patent Application Publication
(10) Pub. No.: US 2007/0063851 A1
(43) Pub. Date: Mar. 22, 2007

(54) Personal advance warning system

(76) Inventors: Brenda F. Addison, Rockville, MD (US); Brandon J. Addison, Rockville, MD (US)

Correspondence Address: LITMAN LAW OFFICES, LTD, PO BOX 15035, CRYSTAL CITY STATION, ARLINGTON, VA, 22215, US

(21) Appl. No.: 11/525,161

(22) Filed: Sep. 22, 2006

Related U.S. Application Data
(60) Provisional application No. 60/719,217, filed on Sep. 22, 2005.

(51) Int. Cl. G08B 23/00

(52) U.S. Cl. 340/573.1

(57) ABSTRACT

A personal advance warning system in the form of a portable, wearable device, the system being adapted to detect and alert the wearer of a possible threat to his/her safety. The system employs an array of infrared sensors to detect body heat from humans or animals at a distance of approximately fifteen feet, which provides a buffer zone to give a wearer time to make a decision as to the authenticity of the threat and to avoid sudden surprise. Integrated circuitry converts signals from the sensors into an audible warning and a text message. The text message indicates the location and the type (human or animal) of the potential threat. Each sensor of the array is located in a different area on the device.

### CROSS-REFERENCE TO RELATED APPLICATION

This application claims the benefit of U.S. Provisional Patent Application Ser. No. 60/719,217, filed Sep. 22, 2005.

### BACKGROUND OF THE INVENTION

1. Field of the Invention

The present invention generally relates to detection and warning systems. More specifically, the present invention is drawn to a portable detection and warning device for personal use.

2. Description of the Related Art

Unfortunately, enjoying an outdoor lifestyle in today's world includes living with the perils attendant with crime. Far too often news reports describe a stealth attack on a jogger, hiker, or biker in an urban, suburban or rural federal park. Such attacks also occur on secluded streets. In many instances the attacks result in death or permanent injury. It is probable that a high percentage of such attacks could be avoided if the potential victim had a device to detect the presence of the would-be assailant and emit a warning shortly before the attack's onset. Utilization of the aforementioned device would permit the potential victim to make a timely decision that could possibly avert or avoid the potential attack. The device could also be employed to warn of potential threats such as animal attacks, peeping toms, home invasion and the like. Further, the device could be adapted in military situations to aid in distinguishing enemy combatants from friendly forces.

Thus, a personal detection and warning device solving the aforementioned problems is desired.

### SUMMARY OF THE INVENTION

The present invention is a personal advance warning system in the form of a portable, wearable device, which system is adapted to detect and alert the wearer of a possible threat to his/her safety. The system employs an array of infrared sensors to detect body heat from humans or animals at a distance of approximately 15 feet, which provides a buffer zone to give a wearer time to make a decision as to the authenticity of the threat and to avoid sudden surprise. Integrated circuitry converts signals from the sensors into an audible warning and a text message. The text message indicates the location and the type (human or animal) of the potential threat. Each sensor of the array is located in a different area on the device. As presently contemplated a respective sensor will be positioned at the front, rear and both sides of the device.

The system also incorporates GPS technology that discloses the exact locations of the wearer and the potential threat. As presently contemplated, threats will be posted on a readable interface having a built-in background lighting system similar to that of a cell telephone interface, thus permitting day or night reading. Potential human threats will be depicted, as red circles while animals will appear as red dots. If adapted for military applications, all friendly forces wearing the system would be displayed in blue, while enemy forces would be shown as red.

Accordingly, the invention presents a first embodiment of a personal advance warning system that is adapted to be supported on the wearer's wrist. A second embodiment is designed to be attached at the wearer's waist. The invention provides for improved elements thereof in an arrangement for the purposes described that are inexpensive, dependable and fully effective in accomplishing their intended purposes.

A clear understanding of the present invention will become readily apparent upon further review of the following specification and drawings.

### BRIEF DESCRIPTION OF THE DRAWINGS

FIG. 1 is an environmental, perspective view of a personal advance warning system according to the present invention.

FIG. 2 is a perspective view of a first embodiment of a personal advance warning system according to the present invention.

FIG. 3 is a perspective view of a second embodiment of a personal advance warning system according to the present invention.

Similar reference characters denote corresponding features consistently throughout the attached drawings.

### DETAILED DESCRIPTION OF THE PREFERRED EMBODIMENTS

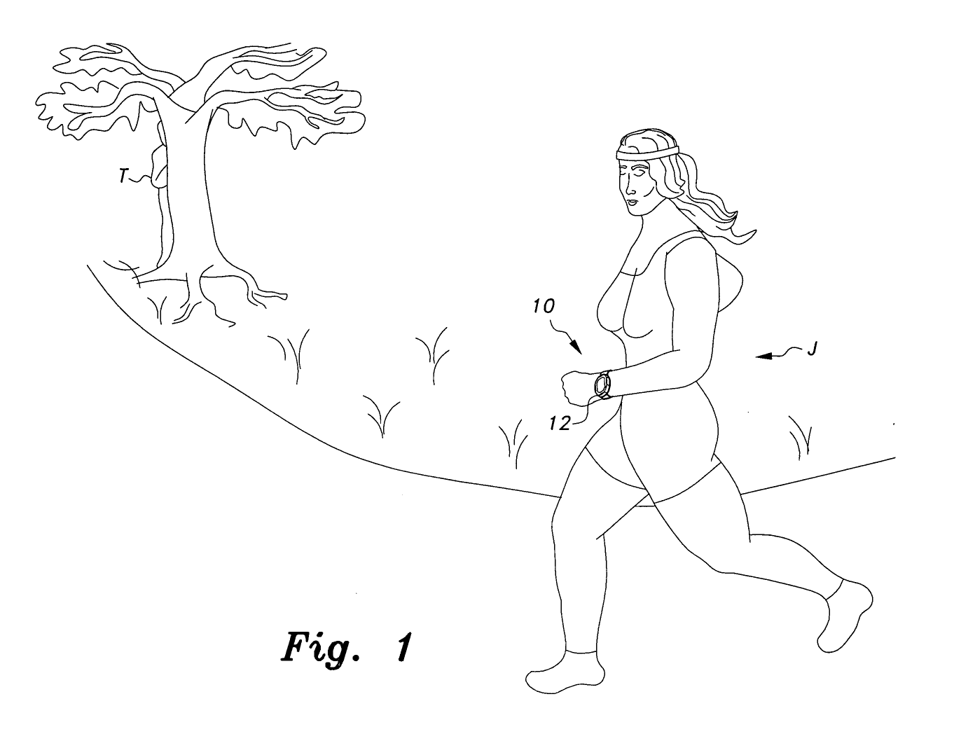

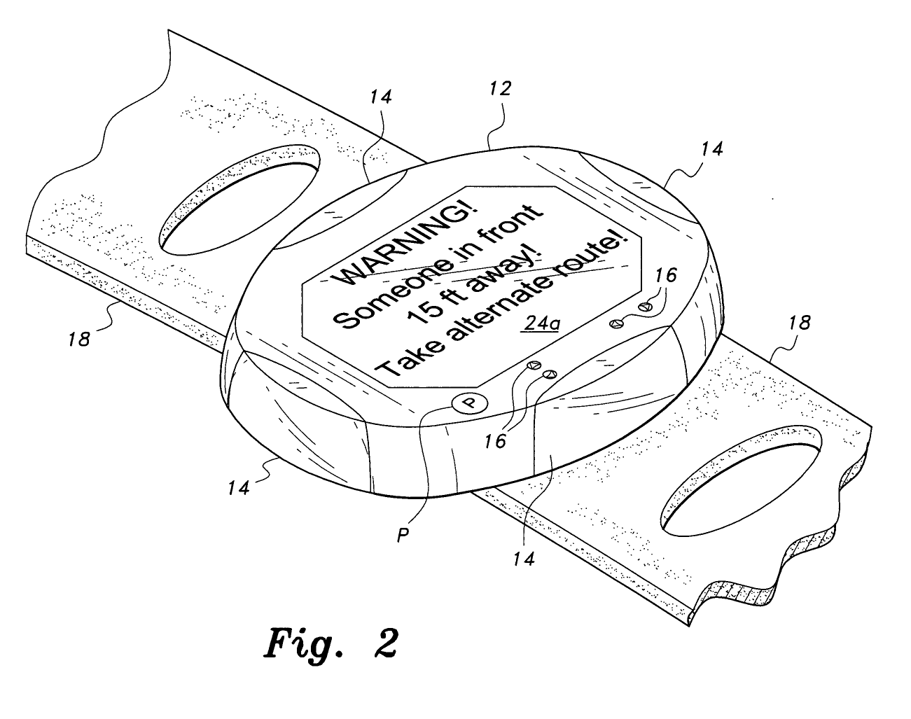

Attention is first directed to FIGS. 1 and 2 wherein a first embodiment of a personal advance warning system of the present invention is generally indicated at 10. System 10 is incorporated in a device 12. Device 12 is designed to resemble a watch casing. Although the user is represented as a jogger J, it is recognized that the device can be utilized by a person engaged in almost any activity that might lend itself to the need of an advance-warning device. As noted above, device 12 will initially emit a warning signal when a hidden potential threat T is detected within a certain range of user J.

As best seen in FIG. 2, device 12 is formed as a housing having a front face. An array (at least four) of infrared sensors 14 is evenly spaced around the periphery of the device 12. The spacing of the sensors is such that a respective sensor is directed to the front, rear and both sides of the wearer J. An illuminated readout interface 24a is disposed on the front face of the device. Integrated circuitry (not shown) is housed within the device for converting the signals detected by sensors 14 into an initial audible warning signal and into a readable text message. The circuitry also incorporates a GPS component that will provide the instantaneous locations of the wearer J and the potential threat T. The front face is also provided with a power button P to control on/off operations and a series of menu controls 16 for selecting various readout functions. Conventional straps 18 are utilized to secure the device to the wearer's wrist.

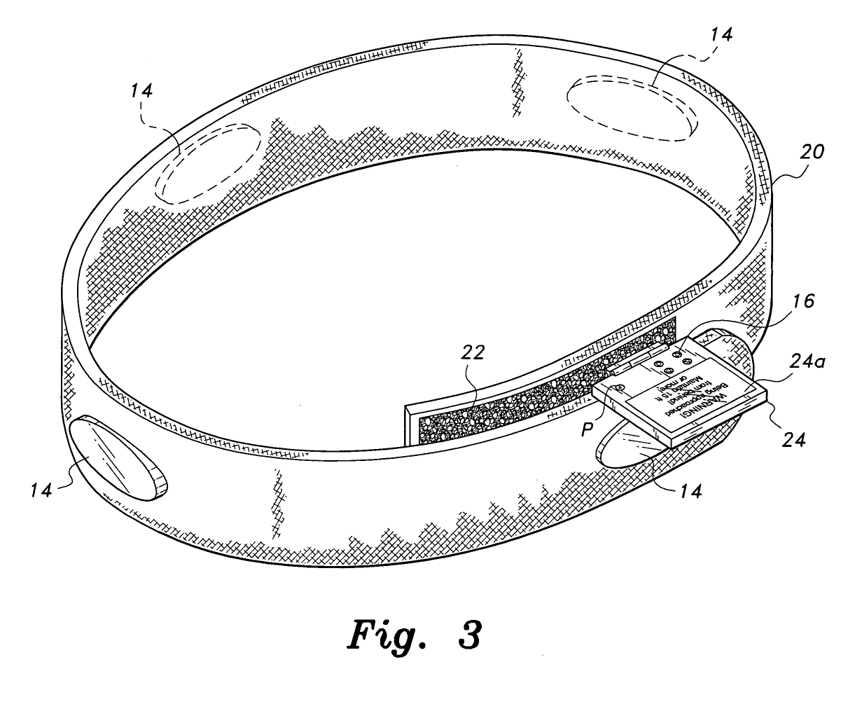

FIG. 3 is illustrative of a second embodiment of the invention adapted to be secured around the waist of a user. The instant embodiment comprises an elongate strip 20 having hook and loop fasteners 22 disposed at the ends thereof so that the strip can be adjusted to securely fit around the waist of the user. Infrared sensors 14 are spaced around and secured to strip 20 for reasons as indicated above. Integrated circuitry (not shown) is housed within the strip for converting the signals detected by sensors 14 into an initial audible warning signal and into a readable text message. A monitor 24 is pivotally attached to strip 20 adjacent one end thereof. The pivotal attachment permits the wearer to adjust the position of the monitor for easy observation thereof. The inner face 24a, of monitor 24, functions as an illuminated readout interface for displaying text messages and GPS data. A power button P and menu controls 16 are disposed on face 24a.

It is to be understood that the present invention is not limited to the embodiments described above, but encompasses any and all embodiments within the scope of the following claims.

We claim:

1. A personal advance warning system, comprising:
a housing device, said housing having a periphery;
an array of infrared sensors disposed on said housing device and spaced evenly around said periphery;
a readable interface mounted on said housing device for converting signals detected by said infrared sensors into an audible signal and a text message.

2. The personal advance warning system according to claim 1, wherein said housing device is a casing.

3. The personal advance warning system according to claim 1, wherein said housing device is an elongate strip.
